(19) United States
(12) Patent Application Publication
(10) Pub. No.: US 2023/0076956 A1
(43) Pub. Date: Mar. 9, 2023

(54) ANXIETY CALMING ANIMAL GARMENT

(71) Applicant: Wenzhou Midali Pet Product Co. Ltd., Metuchen, NJ (US)

(72) Inventor: Dingzhang Chen, Wenzhou (CN)

(21) Appl. No.: 17/729,958

(22) Filed: Apr. 26, 2022

(30) Foreign Application Priority Data
Sep. 8, 2021 (CN) 202122161635.8

(51) Int. Cl. A01K 13/00

(52) U.S. Cl. CPC A01K 13/006

(57) ABSTRACT

This animal garment has a pair of flaps and a neck connecting strap with hook-and-loop fasteners. The garment traverses the animal's neck and body. By fastening securely through hook-and-loop fasteners, it creates constant pressure on the animal so that the animal would feel like it is being hugged by a human being.

### CROSS-REFERENCE TO RELATED APPLICATIONS

This application claims priority from China Patent Application Serial Number 202122161635.8, which was filed on Sep. 8, 2021, the entire content of which is incorporated herein by reference.

### BACKGROUND OF THE INVENTION

Outside stimulus such as traveling, thunderstorms, physical contact with strangers may likely trigger an animal's stress responses. To mitigate these negative situations, animal owners may use various ways such as music, massage, or hugging to comfort the animal. Holding or swaddling is an effective way to make the animals feel secure and comfortable.

As animal owners are sometimes absent when stressful events happen around animals, a design to provide the animals with an improvised human-like hugging sensation is helpful to comfort the animal in stressful situations. This patent is an animal garment with an anxiety calming effect. When it is worn by an animal, the animal would feel gentle yet constant pressure generated by fastening mechanisms used in the design, which creates a sense of human-like hugging on the animal, thus relieving its anxiety and stress during stressful circumstances.

### SUMMARY OF THE INVENTION

The invention contemplates an animal garment. This animal garment includes a garment main body, a pair of flaps extending laterally from opposite sides of the central portion of the garment, and a front neck connecting strap. The main body has a front portion, which has holes on each side, allowing the front neck connecting strap to pass through then become secured through a fastening mechanism on the strap itself. When the garment is worn by the animal, the front portion of the garment main body and the front neck connecting strap would extend around the animal's neck, while the flaps would extend around the animal's mid-body.

At the end of each flap, there is a section of one of the hook fasteners or loop fasteners on the inside surface. There is a section of the other of the hook fasteners or loop fasteners at the end of the first flap and in the central portion of the garment main body, respectively, on the outside surface. There is a hole on the first flap, and a hole on each side of the front portion of the garment main body. When the garment is put on the animal, the front neck connecting strap would pass through the holes in the front portion of the garment main body, and then become secured by a fastening mechanism on the strap itself. By exercising gentle and constant pressure, the garment would create an impression on the animal that it is being hugged by a human.

### BRIEF DESCRIPTION OF THE DRAWINGS

The following is a brief description of the drawings:

FIG. 1 is a three-dimensional top plan view of the animal garment.

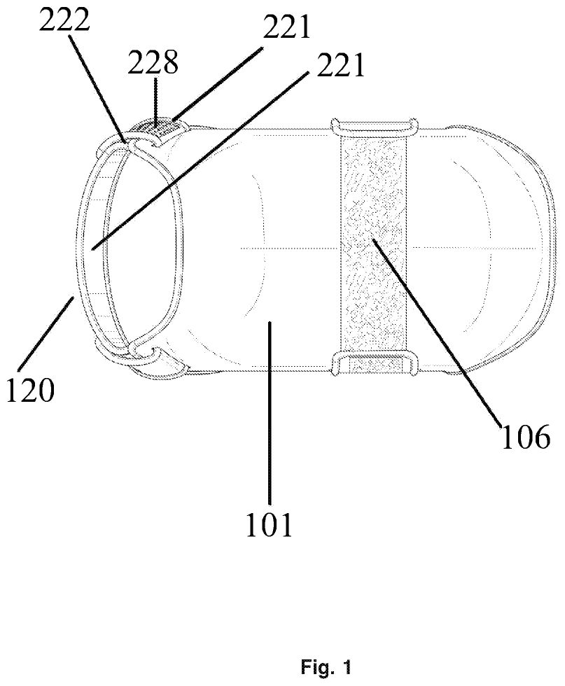

FIG. 2 is a perspective view of the animal garment securely fastened on an exemplary animal.

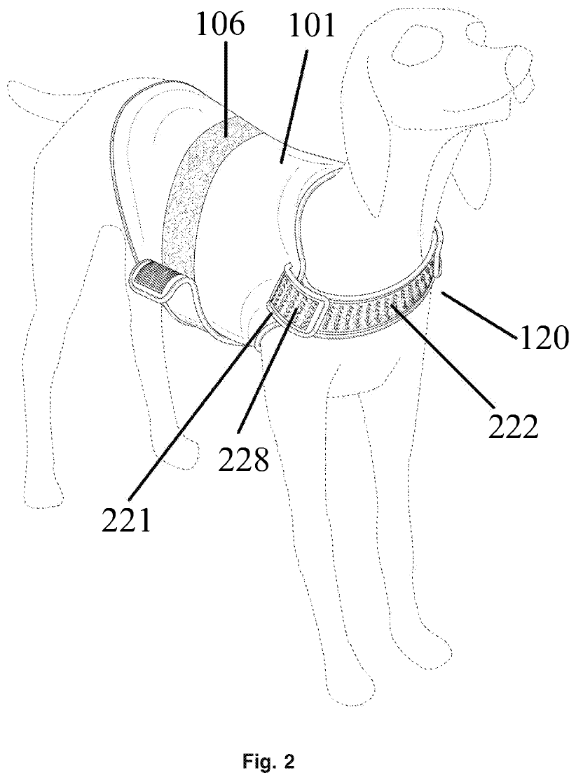

FIG. 3 is a second perspective view of the animal garment securely fastened on an exemplary animal.

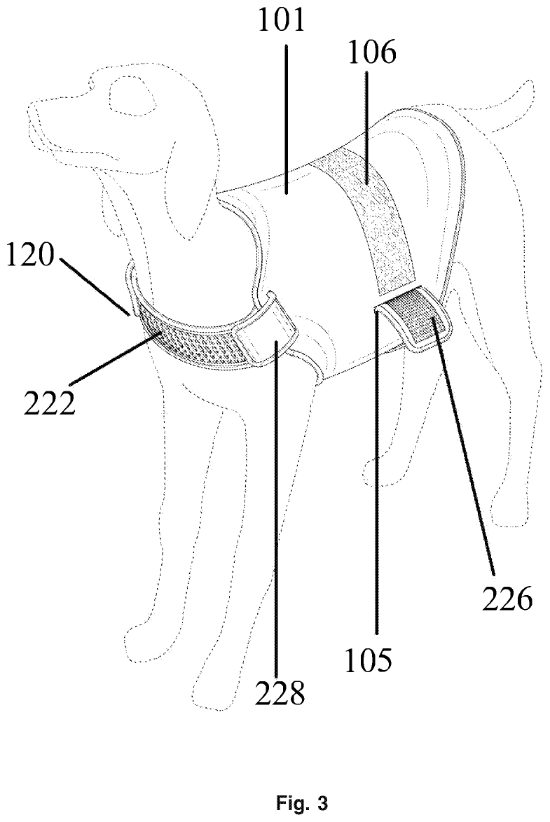

FIG. 4 is a third perspective view of the animal garment securely fastened on an exemplary animal.

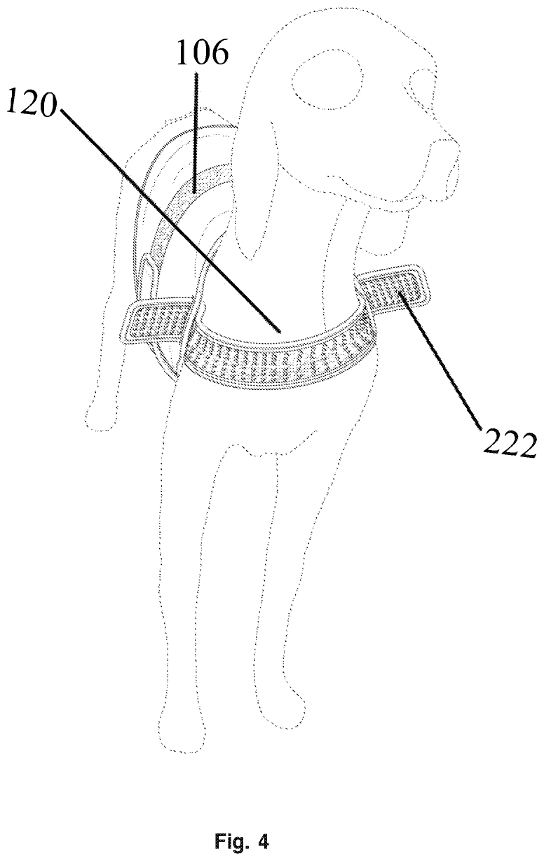

FIG. 5 is a two-dimensional top plan view of the animal garment.

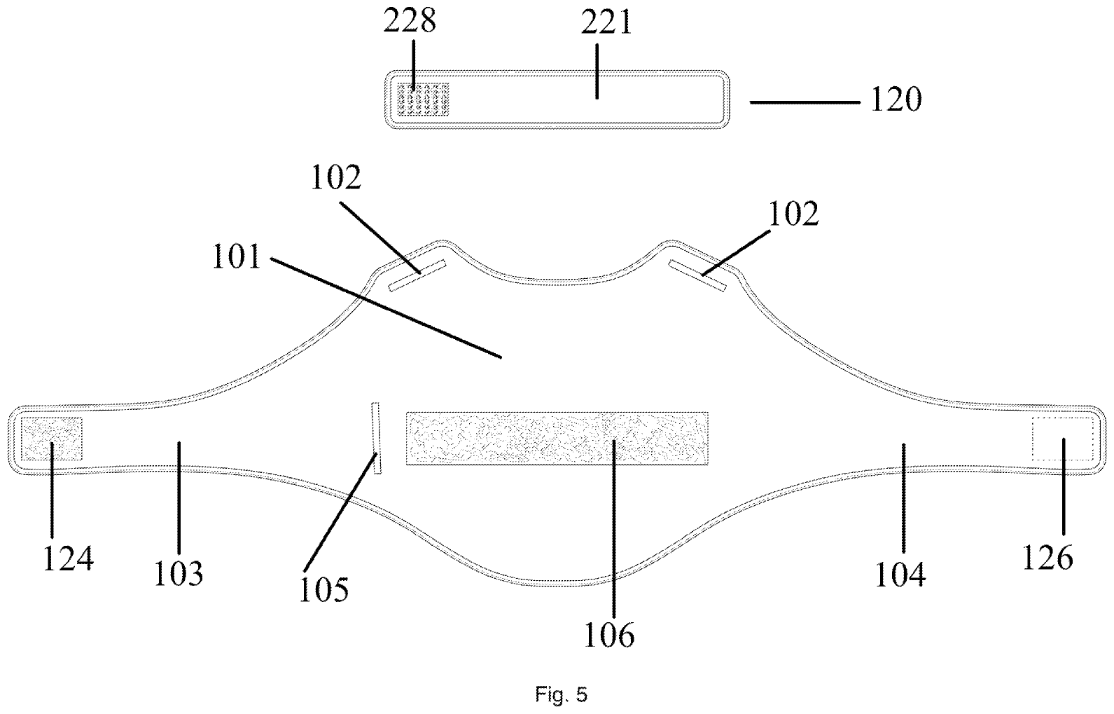

FIG. 6 is a two-dimensional bottom plan view of the animal garment.

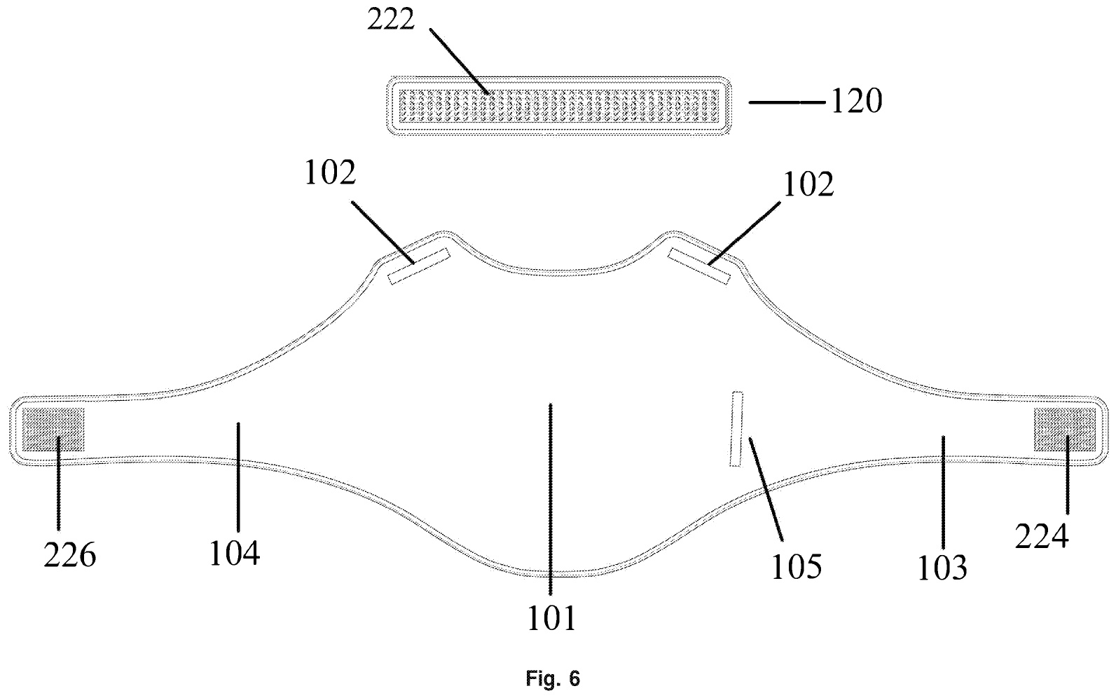

### DETAILED DESCRIPTION OF INVENTION

This is an animal garment with a pair of flaps and a front neck connecting strap that, when worn by an animal, extend around the animal's neck and mid-body, respectively. Due to the fastening mechanism used in the design, the flaps and the front neck connecting strap are fastened securely in a way that creates a “squeezing” sensation for the animal.

This animal garment includes a garment main body 101, a front neck connecting strap 120, and a first flap 103 and a second flap 104 extending laterally from opposite sides of the central portion of the garment main body 101. The garment main body 101 has a front portion, which has a hole 102 on each side, allowing the front neck connecting strap 120 to pass through and then become secured through a fastening mechanism on the strap itself. There is a section of mixed hook and loop fasteners on the inside surface 222 of the front neck connecting strap 120; and on the outside surface 221, there is a section of mixed hook and loop fasteners on one end 228 of the front neck connecting strap 120.

At the end of each flap 103, 104, there is a section of one of the hook fasteners or loop fasteners on the inside surface 224, 226. There is a section of the other of the hook fasteners or loop fasteners at the end of the first strap 124, and the central portion of the garment main body 106, respectively, on the outside surface.

There is a hole 105 on the first flap 103. When the garment is put on the animal, the second flap 104 would wrap around the animal's belly, travel through the hole 105 on the first flap 103 and then become fastened to the fastener section 106 of the outside surface of the central portion of the garment main body, or travel further to be fastened to the fastener section 124 on the outside surface at the end of the first flap.

As to the front neck connecting strap 120, there is a section of mixed hook and loop fasteners on the inside surface 222. When the garment is put on the animal, one end of the front neck connecting strap 120 would pass through the hole 102 on one side of the front portion of the garment main body 101, double back, and then become secured by the mixed hook and loop fasteners on the inside surface 222. The remaining of the front neck connecting strap 120 would pass through the hole 102 on the other side of the front portion of the garment main body, double back and then become secured by either the mixed hook and loop fasteners on the inside surface 222, or travel further and become secured by the mixed hook and loop fasteners 228 on the outside surface of the strap 120.

Therefore, when the garment is worn by the animal, the front portion of the garment main body and the front neck connecting strap would extend around the animal's neck, while the flaps would extend around the animal's mid-body.

In some embodiments, the hook fasteners and loop fasteners are replaced with mixed hook and loop fasteners.

In some embodiments, the hook and loop mechanism on the garment main body, the two flaps, or the front neck connecting strap are changed to a button mechanism, a magnet mechanism, a press stud mechanism, or other mechanisms that would similarly generate gentle and constant pressure on the animal.

Putting the garment tightly around the animal can create the impression of a warm embrace from a human being. Nevertheless, the flaps or the strap can be fastened with as much or as little force and strength as the animal owner desires, thereby customizing the effect on the animal.

This description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

1. A garment for an animal, comprising
a front neck connecting strap, which includes mixed hook and loop fasteners on the inside surface, and a section of mixed hook and loop fasteners at one end on the outside surface;
a central portion that has a longitudinal axis, and includes a front end with a hole on each side and a rear end opposite the front end;
wherein when the garment is put on the animal, the end of the front neck connecting strap with fasteners on the outside surface would pass the hole on one side of the front end of the central portion of the garment, double back, then become secured by the mixed hook and loop fasteners on the inside surface, while the remaining of the front neck connecting strap would pass through the hole on the other side of the front portion of the garment main body, double back, then become secured by either the mixed hook and loop fasteners on the inside surface of the front neck connecting strap, or travel further and become secured by the mixed hook and loop fasteners on the outside surface of the front neck connecting strap.

2. A garment for an animal, comprising
a central portion having a longitudinal axis, and including a section of one of hook fasteners or loop fasteners on the outside surface;
a first flap, which has a hole, extending laterally in a first direction from the longitudinal axis of the central portion, with a section of one of hook fasteners or loop fasteners on the inside surface at the end and a section of the other hook fasteners or loop fasteners on the outside surface at the end;
a second flap, extending laterally in a second direction, which is the opposite direction of the first direction, from the longitudinal axis of the central portion, with a section of one of hook fasteners or loop fasteners on the inside surface at the end;
wherein when the garment is put on the animal, the second flap wraps around the animal's belly, goes through the hole in the first flap, and then becomes fastened to the fasteners on the outside surface of the central portion, or travels further to be fastened to the fasteners on the outside surface at the end of the first flap.
